(19) United States
(12) Patent Application Publication
(10) Pub. No.: US 2005/0071214 A1
(43) Pub. Date: Mar. 31, 2005

(54) Method and apparatus for obtaining web-based advertising research data

(76) Inventors: Arthur J. Kover, Clintin, CT (US); Owen Davis, Flemington, NJ (US); Richard R. Berke, Doylestown, PA (US)

Correspondence Address: Steven S Payne, 6027 ILIFF Drive, Dunn Loring, VA, 22027, US

(21) Appl. No.: 10/669,567

(22) Filed: Sep. 25, 2003

(51) Int. Cl. G06F 17/60

(52) U.S. Cl. 705/10; 705/7; 705/14

(57) ABSTRACT

A method for obtaining web-based advertising research data over a network is disclosed. User reaction data of at least one user to at least one advertisement displayed on a web site is collected. Questions are then posed to said at least one user based on said gathered user reaction data.

### FIELD OF THE INVENTION

The present invention relates generally to obtaining comprehensive research data on the effectiveness of an advertisement. More particularly, the present invention relates to a method and apparatus for obtaining web-based advertising research data on the effectiveness of an advertisement over a communications network such as the Internet.

### BACKGROUND OF THE INVENTION

The objective of advertising research seems rather straightforward, predict how an advertisement will be perceived in the real world. However, it is not really that easy, as the reactions to advertisements are often very complex and not completely understood.

There are several key questions which need to be addressed during the measurement process. First, it needs to be determined whether the advertising breaks through the clutter of other advertising. The elements in the advertising which attract attention need to be determined. It also needs to be determined what the advertisement communicates to the viewers. Finally, it needs to be determined what is persuasive about the advertisement.

While the total measurement process is more complex, factors one and three, listed above, are two of the more difficult phases in the research process. Obviously, advertising can not convey important messages if the viewer or reader does not see or hear the communication. In particular, for print advertising and concept testing, it needs to be determined what the person actually sees or comprehends. Studies have shown in consumer advertising, the average magazine advertisement attracts less than two seconds of viewer attention. Thus, it is crucial for an advertisement to make an impression on the viewer's first and potentially only glance at the advertisement.

One known method for measuring what is being communicated to viewers is the so-called “eye tracking” method. This method is very expensive and involves intricate equipment. The eye tracking method assesses what the viewer sees by using a special camera that tracks the motion of a person's eyes as he or she looks at an advertisement on paper or on a monitor. The camera captures critical information such as what a person sees first, what element has the greatest impact on the viewer, what words the person sees and whether the brand's logo is identified.

Although this method is typically used for print advertising, it is equally suited for broadcast commercials. However, many advertising researchers shy away from the eye tracking method for several reasons. First, it is usually a separate process from traditional advertising testing of impact, communication and persuasion. Furthermore, this method is expensive to conduct and only a few companies offer the technology. Finally, although some progress has been made, the equipment needed to perform the eye tracking method is rather cumbersome, which means that eye-tracking is usually conducted from a central fixed location.

Accordingly, it is desirable to provide a method for obtaining advertising research data without the need for complicated and cumbersome equipment and that can be obtained from a multitude of locations and participants.

### SUMMARY OF THE INVENTION

It is therefore a feature and advantage of the present invention to provide a method and apparatus for obtaining low cost advertising research data using a communications system such as the Internet. The present invention combines a point-and-click feature and the interactivity of the Internet to identify the actionable words, phrases and/or objects in an advertisement, and define what they mean to each participant through a series of questions.

In accordance with one embodiment of the present invention, a method for obtaining web-based advertising research data over a network is disclosed. User reaction data of at least one user to at least one advertisement displayed on a web site is collected. Questions are then posed to said at least one user based on said gathered user reaction data.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will now be described, by way of example, with reference to the accompanying drawings, wherein:

FIG. 1 illustrates a computer system according to one embodiment of the invention;

FIG. 2 illustrates a flow chart showing the operation of the computer system according to one embodiment of the invention;

FIGS. 3-10 illustrate web pages shown to users who participate in a survey according to embodiments of the invention; and

FIGS. 11-12 illustrate displayed results from a user survey according to embodiments of the invention.

### DETAILED DESCRIPTION OF PREFERRED EMBODIMENTS OF THE INVENTION

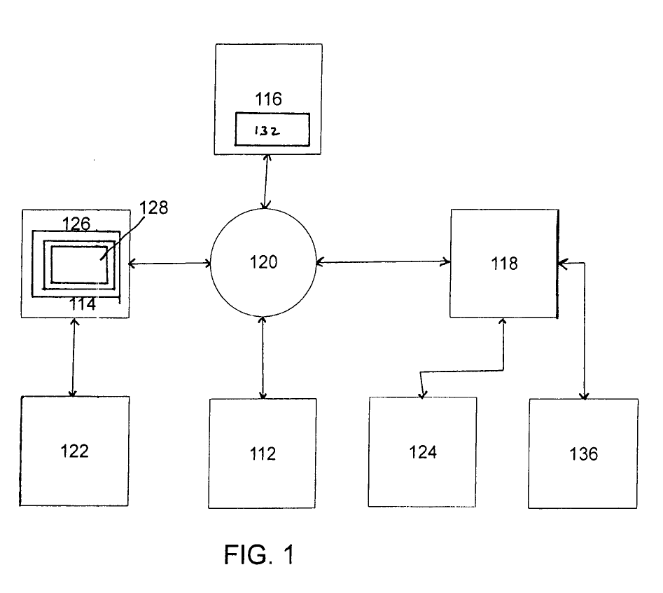

FIG. 1 illustrates an exemplary system 100 for obtaining web-based advertising research data over a communications network, such as the Internet, according to one embodiment of the invention. As described more fully below, the system 100 allows a multitude of participants to view advertisements over the Internet and records their reactions and thoughts about the advertisements through a series of requests and questions. According to one embodiment of the invention, the research participant is asked routine advertising research questions in the course of reviewing an advertisement. The participant is then asked to look at the advertisement again, and directed to use a mouse to indicate which part of the advertisement he or she noticed first. If necessary, further questions can also be asked. While this approach relies on the participant's memory, experience has shown that answers remain generally in accord with results obtained using the eye tracking method. Thus, similar research data can be obtained using the present invention without the need for special eye tracking equipment.

Using the interactivity of the Internet, the present invention can provide precise, effective web-based advertising research data, which was previously only possible using eye tracking technology and specialized in-depth qualitative research. The present invention can provide powerful insights into why advertising does and doesn't work. The present invention can enrich knowledge, and speed and enhance the decision making process within the framework of qualitative research without the expense and problems associated with the eye-tracking method.

The exemplary system 100 includes a website owner 112, a web server 114, one or more website participants 116, and a reporting server 118 coupled to one another using a network 120. It will be understood by those skilled in the art that the network may be any suitable local area network (LAN), metropolitan area network (MAN, wide area network (WAN), a global communications network such as the Internet, or any other suitable network. Although the owner 112, the server 114, the participants 116, and the server 118 are described as coupled using a single network 120, the present invention contemplates multiple networks 120 of the same type or different types to couple these components together, according to particular needs. The owner 112 and the participants 116 may each be autonomous computer systems or may receive appropriate input from one or more associated persons. The servers 114 and 118 may include software operating on one or more computer systems 122 and 124, respectively, at one or more locations. The owner 112, the server 114 and the server 118 may operate on at least one shared computer system. The computer systems associated with the owner 112, the participants 116, the servers 114 and 118 include input devices, output devices, processors, memories, and other components suitable for the features and operations described below.

The web server 114 hosts or otherwise supports at least one website 126 including one or more pages 128. Although the pages 128 are described primarily as web pages 128 associated with a typical website 126, the present invention contemplates measuring and reporting user reactions to files, documents, or any other formatted information. Moreover, although a single website 126 for a single owner 112 is described in detail, the server 114 may support one or more websites 126 for each of multiple owners 112.

In general, using an associated web browser or other software component, the participant 116 provides a uniform resource locator (URL) or other electronic address to establish a connection to the server 114 and access a particular page 128 associated with the website 126. The server 114 communicates the requested page 128 to the participant 116 using the network 120, the participant 116 receives the page 128, and the participant 116 views or otherwise processes the page 128 according to the participant's particular needs. The participant 116 will typically provide one or more additional URLs during a single browser session to access additional pages 128 associated with the website 126, navigating through the topography of the website 126 according to particular needs. Multiple participants 116 may access a single page 128 substantially simultaneously. The present invention contemplates one or more website participants 116 accessing one or more pages 128 of the website 126 in a suitable manner during one or more browser sessions.

According to one embodiment of the invention, a series of pages 128 are used to gather a variety of information from the participant 116 with respect to at least one advertisement. As will be described below, the participant's responses comprise word response to questions and/or point-and-click data, for example, the location of at least one feature in the advertisement which has the most impact, and the location of the first feature in the advertisement noticed by the participant. The participant's responses are collected, for example in a data array, and then sent via the network 120 to the server 118 and stored in a database 136. Software in the server and/or the associated computer 124 analyzes and interprets the received data as will be described in more detail below.

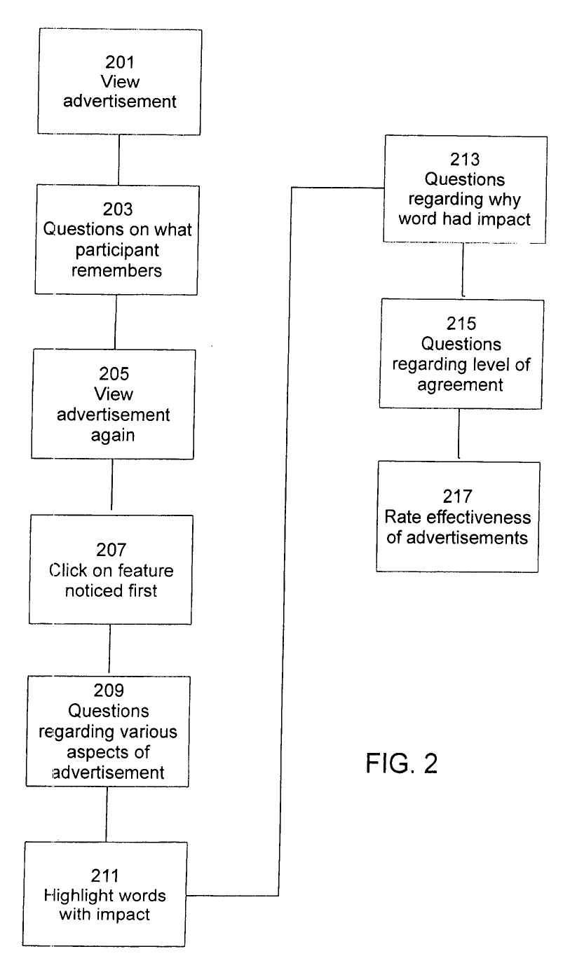

A method for obtaining web-based advertising research data over the Internet according to one embodiment of the invention will now be described with reference to FIG. 2. It will be understood by those skilled in the art that any number of steps illustrated in FIG. 2 can be skipped or the order of the steps can be changed without departing from the scope or spirit of the invention. When a participant 116 enters the website 126 and agrees to participate in research survey, access to a plurality of web pages and other tools are downloaded to the participant's computer 116. One such tool 132 includes data gathering functions that record all of the data entered by the participant 116 during the survey.

In the exemplary embodiment described below, the participant 116 is asked to progress through steps 201-215 for each advertisement in the survey. It will be understood by those skilled in the art that the participant 116 may be presented with all of the steps sequentially for one advertisement before being asked to repeat the process for the next advertisement, or various steps or groups of steps can be performed for each advertisement before the process advances to the next step.

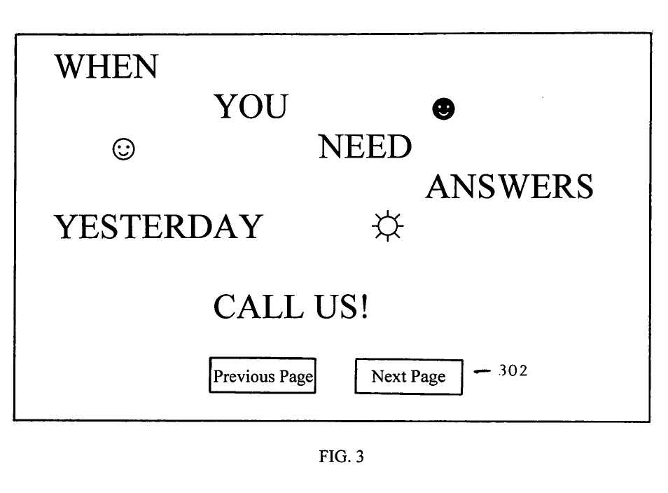

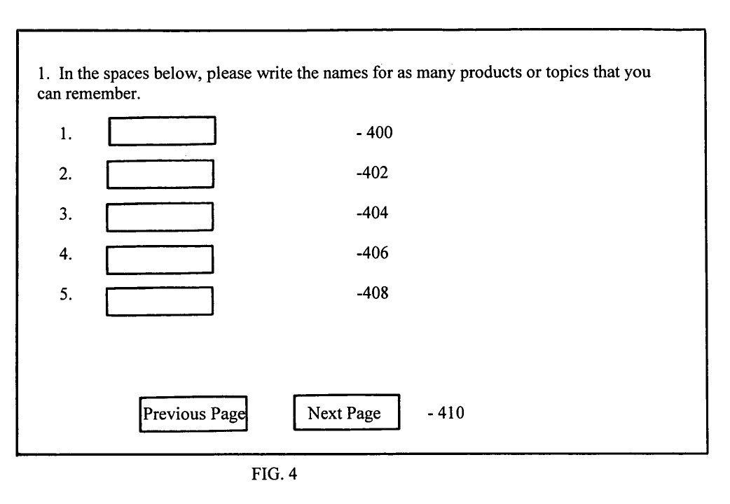

In step 201, the participant 116 is asked to view at least one advertisement on one or more web pages. For example, as illustrated in FIG. 3, an advertisement 300 is displayed for either a predetermined period of time or until the participant clicks on the Next Page” icon 302. The advertisement(s) is displayed for a predetermined period of time and then a new web page is displayed which asks the participant 116 to enter the names for as many products or topics that the participant 116 can remember from the advertisement(s), in step 203. As illustrated in FIG. 4, the participant 116 enters the names into the spaces 400-408 provided using a keyboard or some other means for entering data.

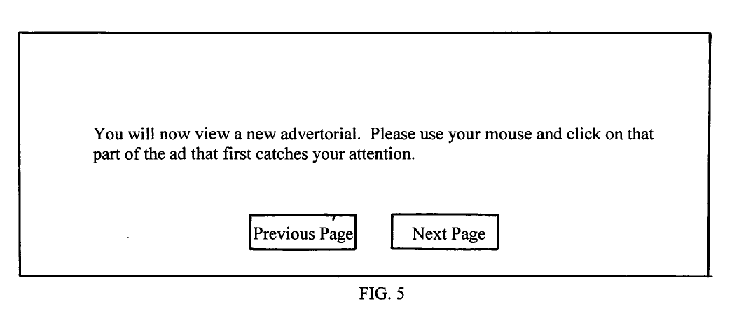

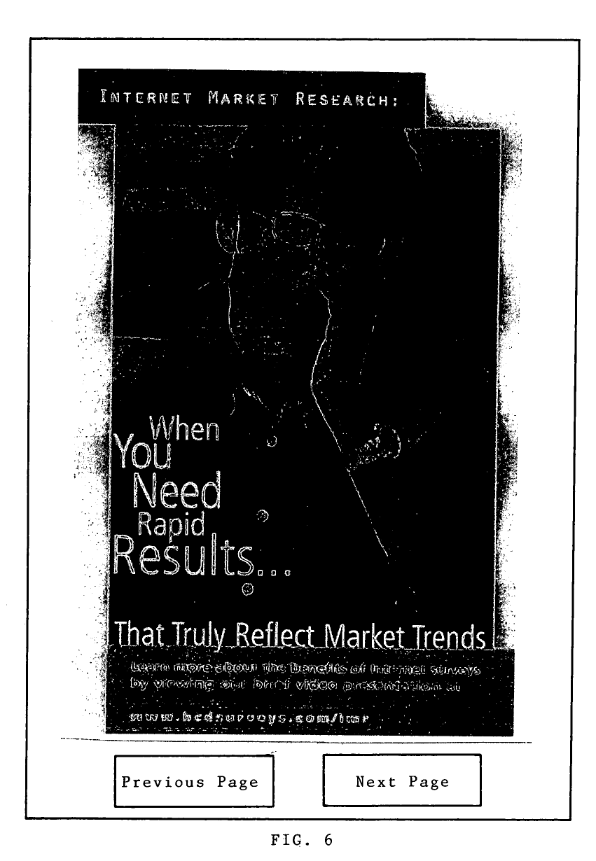

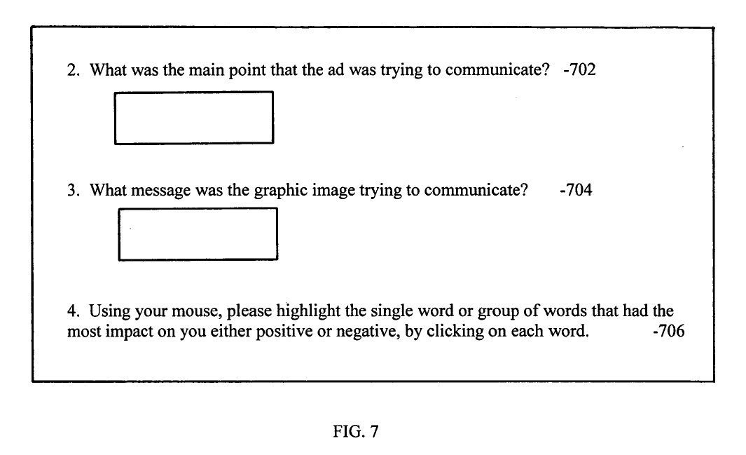

Once the participant 116 has entered the information and clicked on the “Next Page” icon 410, a new page is displayed which instructs the participant 116 that an advertisement is about to be shown and that the participant 116 should use their mouse (or some other pointing means) and click on the part or feature of the advertisement that first catches the participant's attention whether it is a word, phrase, object, person, animal, scene, etc., shown in the advertisement, as illustrated in FIG. 5. In step 205, the advertisement 600 is displayed, as illustrated in FIG. 6, and the participant 116 can use the mouse to click on the appropriate words or objects in step 207. Once the participant 116 has clicked on the appropriate words and/or objects, the participant 116 can be questioned regarding various aspects of the advertisement in step 209. For example, the participant 116 might be asked what was the main point that the advertisement was trying to communicate 702, and/or what message was the graphic image trying to communicate 704. It will be understood that any number of different questions can be asked and the invention is not limited to those illustrated in FIG. 7.

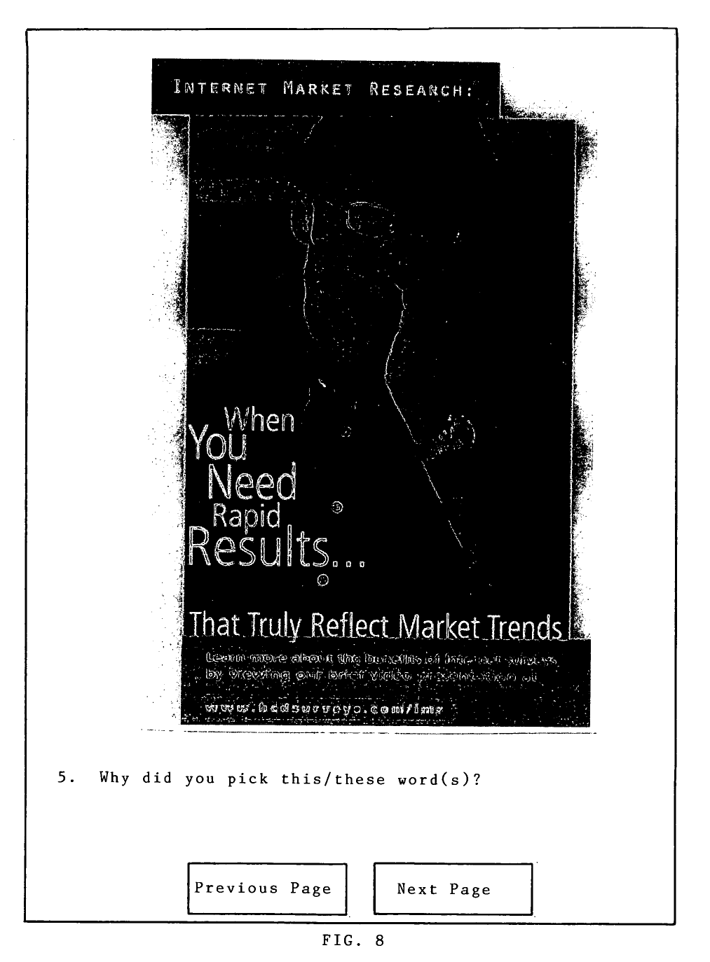

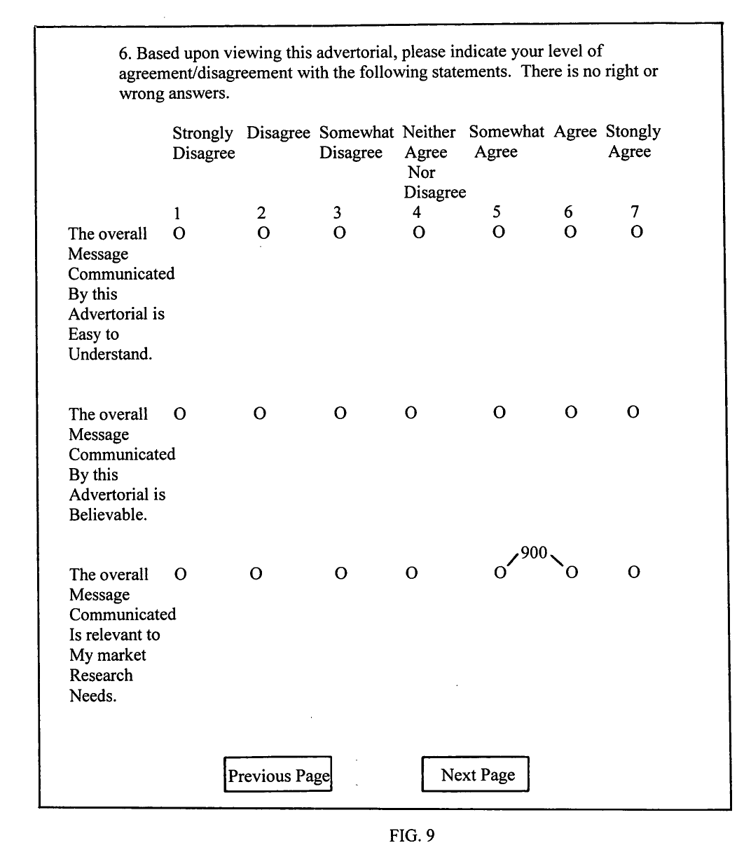

The participant 116 is then asked to highlight a single word or group of words that had the most positive or negative impact on them in step 211. In step 213, the participant 116 is then questioned on why the participant selected the word or words. As illustrated in FIG. 8, the advertisement 800 is shown to the participant 116 and the participant many enter their reasons for highlighting the word or words in the box 802 In this embodiment of the invention, the participant 116 is then shown a screen on which at least one statement is presented as illustrated in FIG. 9. The participant 116 is then asked to indicate their level of agreement/disagreement with the statements by marking the appropriate circle 900 in step 215. For example, the participant 116 can be asked whether the advertisement was easy to understand and/or believable, but the invention is not limited thereto.

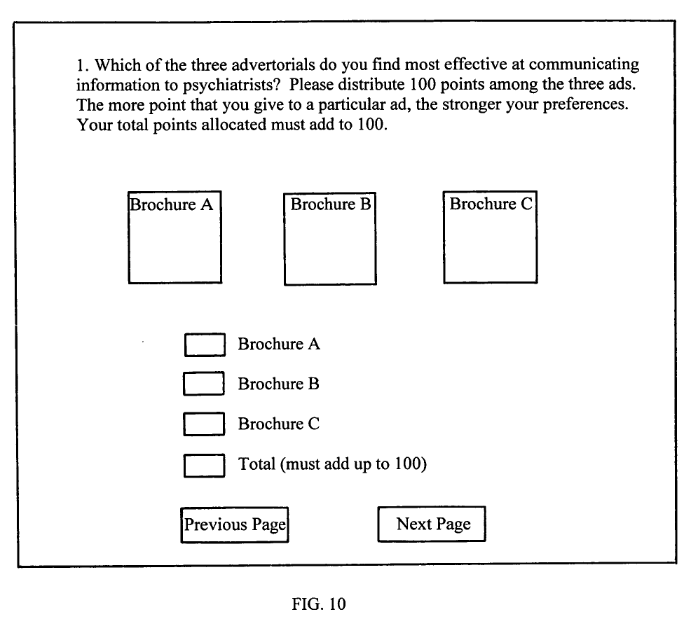

Once the participant 116 has progressed through all of the advertisements in the survey, the participant 116 can be asked to rate the effectiveness of the advertisements which have been shown in step 217. For example, as illustrated in FIG. 10, the participant 116 can be asked to distribute 100 points among the three advertisements 1002, 1004, 1006 which the participant 116 has viewed awarding more points to the advertisement(s) that were deemed to be more effective so long as the total number of points awarded adds up to 100.

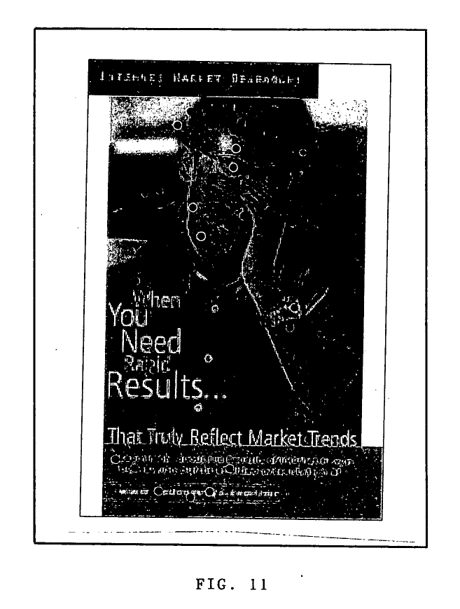

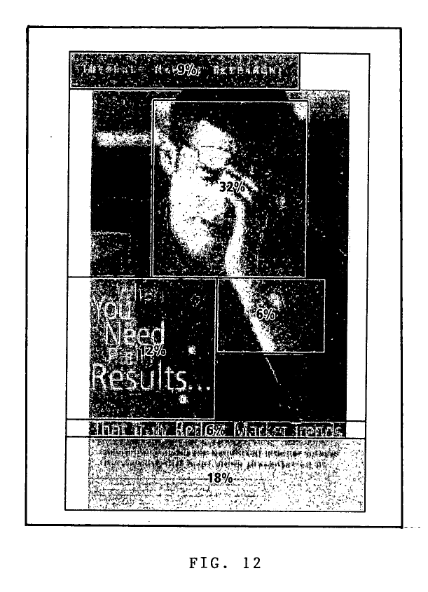

As mentioned above, the data collection tool 132 records all of the information entered by the participant 116 and sends the collected data to the server 118 via the network 120. It will be understood by those skilled in the art that a variety of different methods and devices can be used to extract the data from the user and the invention is not limited thereto. The collected data is then stored in the database 136 for later use by the computer system 124. The collected data can be analyzed and displayed in a variety of different ways depending on the needs of the owner 112 and the invention is not limited to the displays mentioned below. For example, the computer system 124 can display all of the mouse clicks that a plurality of participants have made on each advertisement, for example as illustrated in FIG. 11. Furthermore, the computer system can divide each advertisement into various sections and calculate the percentage of mouse clicks which occurred in each section as illustrated in FIG. 12. Furthermore, the computer system 124 is also capable of transforming some of the word answers entered by the participant into “mouse clicks” for display on the advertisement. For example, certain words or phrases entered by the participant 116 can be interpreted to only be associated with a certain section of the advertisement. Thus, every time the participant 116 uses the certain word or phrase, the computer system 124 can add a mouse click to the total number of collected mouse clicks for each section or advertisement.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method for obtaining web-based advertising research data over a communications system, comprising the steps of:
collecting user reaction data of at least one user to at least one advertisement displayed on a web site;
posing at least one question to said at least one user based on said collected user reaction data.

2. The method according to claim 1, wherein said user reaction data comprises at least one of point-and-click data and word responses to questions.

3. The method according to claim 2, wherein said point-and-click data comprises at least one of location of at least one feature in the advertisement with a greater impact and location of first feature noticed in the advertisement.

4. The method according to claim 3, wherein a feature is a word, phrase, object, person, animal, or scene depicted in the advertisement.

5. The method according to claim 1, further comprising the step of:
analyzing collected data.

6. The method according to claim 5, further comprising the step of:
displaying locations of all point-and-click data collected for the advertisement.

7. The method according to claim 5, further comprising the steps of:
displaying percentage of point-and-click data collected for various sections of the advertisement.

8. The method according to claim 5, further comprising the step of:
transforming word responses into point-and-click data for display.

9. A system for obtaining web-based advertising research data over a communications system, comprising:
a collection tool for collecting user reaction data of at least one user to at least one advertisement displayed on a web site;
means for posing at least one question to said at least one user based on said collected user reaction data.

10. The system according to claim 9, wherein said user reaction data comprises at least one of point-and-click data and word responses to questions.

11. The system according to claim 10, wherein said point-and-click data comprises at least one of location of at least one feature in the advertisement with a greater impact and location of first feature noticed in the advertisement.

12. The system according to claim 11, wherein a feature is a word, phrase, object, person, animal, or scene depicted in the advertisement.

13. The system according to claim 9, further comprising:
a processor for analyzing the collected data.

14. The system according to claim 13, further comprising:
a display device for displaying locations of all point-and-click data collected for the advertisement.

15. The system according to claim 13, further comprising:
a display device for displaying percentage of point-and-click data collected for various sections of the advertisement.

16. The system according to claim 13, wherein the processor transforms word responses into point-and-click data for display.
